(19) United States
(12) Patent Application Publication
(10) Pub. No.: US 2025/0342608 A1
(43) Pub. Date: Nov. 6, 2025

(54) IMAGE PROCESSING TO MEASURE ABSOLUTE SIZE AND LOCATION OF AREA OF INTEREST ASSOCIATED WITH OBJECT

(71) Applicant: Solera Holdings, LLC, Westlake, TX (US)

(72) Inventors: Simon Wengeler, Zurich (CH); Antonio Martinez Albala, Jaen (ES); Marco Kunz, Merligen (CH)

(21) Appl. No.: 18/653,799

(22) Filed: May 2, 2024

(51) Int. Cl. G06T 7/70; G06T 7/20; G06T 7/62; G06T 17/00; G06V 10/25; G06V 10/46

(52) U.S. Cl. CPC G06T 7/70; G06T 7/20; G06T 7/62; G06T 17/00; G06V 10/25; G06V 10/46; G06V 2201/07

(57) ABSTRACT

A method includes obtaining, using at least one processing device, multiple images of a three-dimensional (3D) object. The method also includes generating, using the at least one processing device, a 3D representation of the object with absolute metrics based on the images. The method further includes detecting, using the at least one processing device, one or more areas of interest associated with the object based on the images. The method also includes identifying, using the at least one processing device, a 3D contour of each area of interest, where each 3D contour identifies the area of interest within the 3D representation of the object. In addition, the method includes determining, using the at least one processing device, a location and an absolute size of each area of interest on the object based on the 3D contour of the area of interest and the 3D representation of the object.

### TECHNICAL FIELD

This disclosure generally relates to image processing systems and methods. More specifically, this disclosure relates to image processing to measure the absolute size and location of an area of interest associated with an object.

### BACKGROUND

Estimating the size of an area of interest associated with an object can be a useful or important function in various applications. Unfortunately, determining the size of an area of interest based on two-dimensional (2D) images is typically not an easy task. Some approaches have been developed for this purpose, but these approaches generally require images to be captured in a controlled environment or only consider 2D aspects of the area of interest. For example, these approaches may require the use of a camera having known properties positioned at a known location and a known distance from an object. Moreover, some of these approaches often require additional information (beyond images) in order to estimate the absolute size of an area of interest, and some of these approaches can merely determine if there is an area of interest and not its actual size. In addition, many of these approaches are only able to detect one area of interest associated with an object.

### SUMMARY

This disclosure relates to image processing to measure the absolute size and location of an area of interest associated with an object.

In a first embodiment, a method includes obtaining, using at least one processing device, multiple images of a three-dimensional (3D) object. The method also includes generating, using the at least one processing device, a 3D representation of the object with absolute metrics based on the images. The method further includes detecting, using the at least one processing device, one or more areas of interest associated with the object based on the images. The method also includes identifying, using the at least one processing device, a 3D contour of each area of interest, where each 3D contour identifies the area of interest within the 3D representation of the object. In addition, the method includes determining, using the at least one processing device, a location and an absolute size of each area of interest on the object based on the 3D contour of the area of interest and the 3D representation of the object.

In a second embodiment, an apparatus includes at least one processing device configured to obtain multiple images of a 3D object. The at least one processing device is also configured to generate a 3D representation of the object with absolute metrics based on the images. The at least one processing device is further configured to detect one or more areas of interest associated with the object based on the images. The at least one processing device is also configured to identify a 3D contour of each area of interest, where each 3D contour identifies the area of interest within the 3D representation of the object. In addition, the at least one processing device is configured to determine a location and an absolute size of each area of interest on the object based on the 3D contour of the area of interest and the 3D representation of the object.

In a third embodiment, a non-transitory machine readable medium contains instructions that when executed cause at least one processor to obtain multiple images of a 3D object. The non-transitory machine readable medium also contains instructions that when executed cause the at least one processor to generate a 3D representation of the object with absolute metrics based on the images. The non-transitory machine readable medium further contains instructions that when executed cause the at least one processor to detect one or more areas of interest associated with the object based on the images. The non-transitory machine readable medium also contains instructions that when executed cause the at least one processor to identify a 3D contour of each area of interest, where each 3D contour identifies the area of interest within the 3D representation of the object. In addition, the non-transitory machine readable medium contains instructions that when executed cause the at least one processor to determine a location and an absolute size of each area of interest on the object based on the 3D contour of the area of interest and the 3D representation of the object.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description, taken in conjunction with the accompanying drawings, in which like reference numerals represent like parts:

FIG. 1 illustrates an example system supporting image processing to measure the absolute size and location of an area of interest associated with an object according to this disclosure;

FIG. 2 illustrates an example device supporting image processing to measure the absolute size and location of an area of interest associated with an object according to this disclosure;

FIG. 3 illustrates an example functional architecture supporting image processing to measure the absolute size and location of an area of interest associated with an object according to this disclosure;

FIG. 4 illustrates an example three-dimensional (3D) object representation generation function in the functional architecture of FIG. 3 according to this disclosure;

FIG. 5 illustrates an example pipeline supporting image processing to measure the absolute size and location of an area of interest associated with an object according to this disclosure;

FIGS. 6 through 8 illustrate example results obtained using image processing to measure the absolute size and location of an area of interest associated with an object according to this disclosure; and

FIG. 9 illustrates an example method for image processing to measure the absolute size and location of an area of interest associated with an object according to this disclosure.

### DETAILED DESCRIPTION

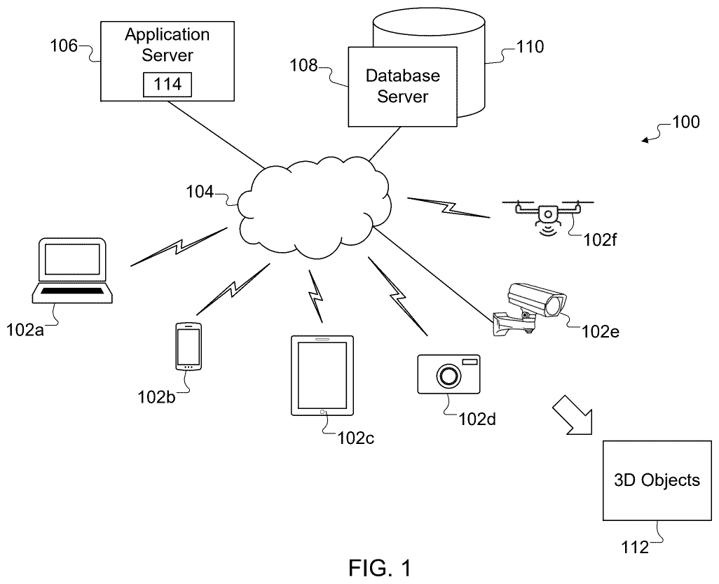

FIGS. 1 through 9, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

As noted above, estimating the size of an area of interest associated with an object can be a useful or important function in various applications. Unfortunately, determining the size of an area of interest based on two-dimensional (2D) images is typically not an easy task. Some approaches have been developed for this purpose, but these approaches generally require images to be captured in a controlled environment or only consider 2D aspects of the area of interest. For example, these approaches may require the use of a camera having known properties positioned at a known location and a known distance from an object. Moreover, some of these approaches often require additional information (beyond images) in order to estimate the absolute size of an area of interest, and some of these approaches can merely determine if there is an area of interest and not its actual size. In addition, many of these approaches are only able to detect one area of interest associated with an object.

This disclosure provides various techniques for image processing to measure the absolute size and location of an area of interest associated with an object. As described in more detail below, images of an object can be obtained, where the images represent 2D image captures of the object. In some cases, the images may represent images captured as part of a video sequence. A three-dimensional (3D) representation of the object in absolute size can be generated and one or more areas of interest can be detected based on the images. Tracking can be used to link the 3D representation with the one or more areas of interest in the images, and the one or more areas of interest can be translated into one or more 3D areas of interest within the 3D representation. This allows for the identification of the absolute size and location of each area of interest, which can be used in various ways.

In this way, the disclosed techniques allow for more effective identification of areas of interest of 3D objects and their characteristics. For example, the disclosed techniques can be used to identify absolute sizes and locations of areas of interest associated with objects based on images captured using a wide variety of image capture devices, including consumer-grade and professional-grade devices. Specific examples of image capture devices can include smartphones, tablet computers, laptop computers, digital cameras, digital video cameras, mounted video inspection systems, surveillance cameras, drones, or optical devices connected to different platforms. Also, the images being processed may be obtained in any suitable manner, such as when images are obtained directly from image capture devices, retrieved from storage systems, or retrieved from cloud-based systems. Moreover, these techniques can avoid the need to capture images in a controlled environment, which can greatly increase the applications in which these techniques may be used. Further, these techniques may not need any other information in order to estimate the absolute sizes and locations of areas of interest, although it is possible to combine image processing with other data to identify sizes and locations of areas of interest. In addition, these techniques enable the identification of absolute sizes and locations of multiple areas of interest associated with a single object.

FIG. 1 illustrates an example system 100 supporting image processing to measure the absolute size and location of an area of interest associated with an object according to this disclosure. As shown in FIG. 1, the system 100 includes one or more user devices 102a-102f, one or more networks 104, one or more application servers 106, and one or more database servers 108 associated with one or more databases 110. Each user device 102a-102f may be able to communicate over the network(s) 104, such as via a wired or wireless connection. Each user device 102a-102f represents any suitable device or system used to capture images that are subsequently processed in order to identify absolute sizes and locations of areas of interest associated with one or more 3D objects 112. In this particular example, the user devices 102a-102f are shown as including a laptop computer, a smartphone, a tablet computer, a digital camera or video camera, a mounted camera like a surveillance camera, and a drone. However, any other or additional types of user devices may be used in or with the system 100, such as extended reality (XR) glasses or headsets or mounted cameras or video cameras used for various purposes.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. In some cases, the network 104 represents at least one public network and at least one private network.

The application server 106 is coupled to the network 104 and is coupled to or otherwise communicates with the database server 108. The application server 106 supports the analysis of images captured or otherwise provided by the user devices 102a-102f or other suitable sources in order to identify the absolute sizes and locations of areas of interest associated with the 3D objects 112. For example, the application server 106 may execute one or more applications 114 that analyze images from the user devices 102a-102f in order to identify the absolute sizes and locations of areas of interest associated with the 3D objects 112. The absolute sizes and locations of the areas of interest may be used in any suitable manner, such as to identify one or more imperfections, damage, or defects; to identify one or more parts, add-ons, or other elements; or to otherwise identify one or more characteristics that can be detected with respect to an object 112. Note that the database server 108 may also be used within the application server 106 to store information, in which case the application server 106 may store the information itself used to perform image analysis. Also note that the functionality of the application server 106 may be physically distributed across multiple devices for redundancy, parallel processing, or other purposes.

The database server 108 operates to store and facilitate retrieval of various information used, generated, or collected by the application server 106 and the user devices 102a-102f in the database 110. For example, the database server 108 may store images captured by the user devices 102a-102f. Note that the functionality of the database server 108 and the database 110 may be physically distributed across multiple devices for redundancy, parallel processing, or other purposes.

The 3D objects 112 may represent any suitable object or objects for which one or more areas of interest may be identified. As examples, a 3D object 112 may represent an automotive vehicle, a boat or other naval vessel, an airplane or other aircraft, or another object being inspected for damage, defects, or other purposes. A 3D object 112 may represent an integrated circuit chip, a heat sink, a television, a washer, a dryer, or another product being inspected for damage, defects, or other purposes. A 3D object 112 may represent a chair, a couch, a lamp, or other furniture or accessory being inspected for damage, defects, or other purposes. A 3D object 112 may represent a house, a building, or another structure being imaged for damage, defects, or other purposes. In general, this disclosure is not limited to use with any particular type(s) of 3D object(s) 112. Each area of interest of a 3D object 112 may represent any suitable portion of the 3D object 112. As examples, one or more areas of interest may represent one or more areas where imperfections, damage, or defects are detected or one or more areas where one or more specific parts or other portions of a 3D object 112 are located. The areas of interest can easily vary depending on the 3D object 112 and the task being performed, and defects, imperfections, damage, and parts are examples of common areas of interest.

Although FIG. 1 illustrates one example of a system 100 supporting image processing to measure the absolute size and location of an area of interest associated with an object, various changes may be made to FIG. 1. For example, the system 100 may include any number of user devices 102a-102f, networks 104, application servers 106, database servers 108, and databases 110 (including zero of one or more of these components). In some embodiments, for instance, the functionality for identifying the absolute size and location of an area of interest associated with a 3D object may be provided within a user device 102a-102f itself, in which case the user device may operate in a standalone manner (at least with respect to this functionality). Also, these components may be located in any suitable location(s) and might be distributed over a large area. Further, while the application server 106 is described above as executing one or more applications 114, the application(s) 114 may be executed by the end user devices 102a-102f for individual users or by one or more cloud computing systems, remote servers, or other networked devices. In general, this disclosure does not require any specific centralized or decentralized implementation. In addition, while FIG. 1 illustrates one example operational environment in which sizes and locations of areas of interest associated with 3D objects 112 may be identified and used, this functionality may be used in any other suitable system.

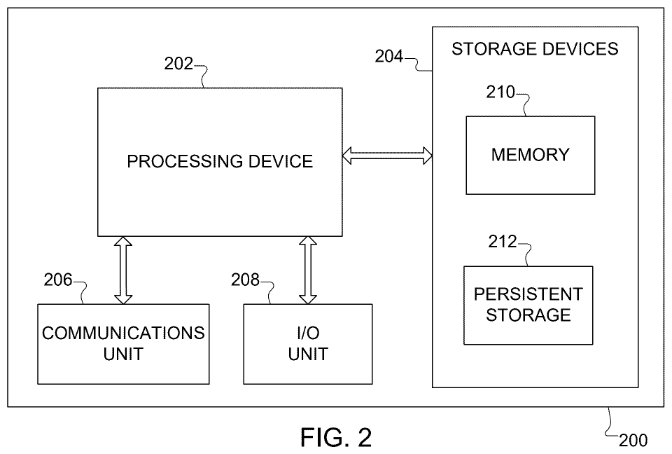

FIG. 2 illustrates an example device 200 supporting image processing to measure the absolute size and location of an area of interest associated with an object according to this disclosure. One or more instances of the device 200 may, for example, be used to at least partially implement the functionality of a user device 102a-102f or an application server 106 in FIG. 1, such as to execute the one or more applications 114 that analyze images and identifies sizes and locations of areas of interest associated with 3D objects 112. However, each user device 102a-102f or application server 106 may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or another suitable input device. The I/O unit 208 may also send output to a display, printer, or another suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement the functionality of the one or more applications 114. Thus, for example, the instructions when executed may cause the processing device 202 to obtain images of 3D objects 112 and process the images to identify sizes and locations of areas of interest associated with the 3D objects 112. Example details of this functionality are provided below.

Although FIG. 2 illustrates one example of a device 200 supporting image processing to measure the absolute size and location of an area of interest associated with an object, various changes may be made to FIG. 2. For example, computing and communication devices and systems come in a wide variety of configurations, and FIG. 2 does not limit this disclosure to any particular computing or communication device or system.

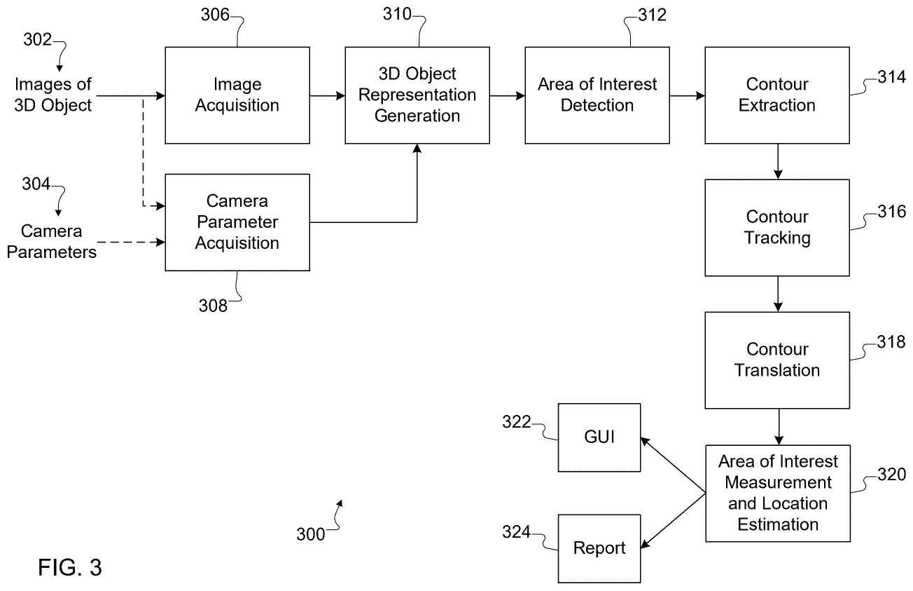

FIG. 3 illustrates an example functional architecture 300 supporting image processing to measure the absolute size and location of an area of interest associated with an object according to this disclosure. The functional architecture 300 may, for example, be implemented using a user device 102a-102f and/or an application server 106 in FIG. 1, each of which may be implemented using one or more instances of the device 200 of FIG. 2. However, the functional architecture 300 may be implemented using any other suitable device(s) and in any other suitable system(s).

As shown in FIG. 3, the functional architecture 300 receives and processes images 302 of a 3D object 112 and optionally one or more camera parameters 304. An image acquisition function 306 can be used to obtain the images 302. The manner in which the images 302 are obtained can vary depending on the implementation. For example, the image acquisition function 306 may acquire the images 302 directly from at least one imaging sensor of a user device 102a-102f, retrieve the images 302 from a local memory of a user device 102a-102f, retrieve the images 302 from a cloud-based or remote storage, or obtain the images 302 in any other suitable manner. In some cases, if the images 302 are generated by a first device (such as a user device 102a-102f) and processed using a second device (such as an application server 106), the second device may obtain the images 302 directly from the first device or indirectly, such as via an auxiliary system that can store and provide the images 302. Note that any suitable number of images 302 may be obtained here, such as two or more images. In some embodiments, the images 302 represent images from a video sequence that records the 3D object 112 or at least the portion(s) of the 3D object 112 in which one or more areas of interest may be identified. Also note that each image 302 may have any suitable dimensions and resolution.

The one or more camera parameters 304 represent one or more parameters associated with the imaging device that captures the images 302. For example, the one or more camera parameters 304 may include one or more extrinsic parameters and/or one or more intrinsic parameters of the imaging device. As particular examples, the one or more camera parameters 304 may include at least one of a focal length, a resolution, a field of view, or a sensor size associated with the imaging device that captures the images 302. The manner in which the one or more camera parameters 304 are obtained can vary depending on the implementation. For example, the one or more camera parameters 304 may be known to the user device 102a-102f and can be input to a camera parameter acquisition function 308 of the architecture 300, or the one or more camera parameters 304 may be derived by the camera parameter acquisition function 308. In some cases, for instance, the one or more camera parameters 304 may be provided by the imaging sensor or by a user device 102a-102f itself, and the one or more camera parameters 304 may be used as described below. In other cases, the one or more camera parameters 304 may be estimated based on the images 302 or other information that might be available. In some embodiments, the one or more camera parameters 304 may be estimated using a computer vision technique or a machine learning model that is designed or trained to process images 302 and other data in order to identify the one or more camera parameters 304. As a particular example, a machine learning model may be trained using at least one training dataset that includes training images and ground truth camera parameters, and the machine learning model can be trained to accurately estimate camera parameters that are close or identical to the ground truth camera parameters using the training images.

The images 302 and the one or more camera parameters 304 are provided to a 3D object representation generation function 310, which generally operates to process the images 302 and the one or more camera parameters 304 to identify a 3D representation of the 3D object 112. For example, the 3D object representation generation function 310 can generate a 3D representation of the 3D object 112 by transforming pixels of the images 302 into 3D coordinates with absolute metrics (such as in meters or centimeters). The phrase “absolute metrics” indicates that a scale of the 3D representation of the object 112 is known such that distances or dimensions associated with the object 112 are represented by or can be determined using the 3D representation of the object 112. The 3D object representation generation function 310 may use any suitable technique to generate a 3D representation of an object, such as by using a computer vision technique or a machine learning model that is designed or trained to process images 302 and one or more camera parameters 304 in order to generate a 3D representation of an object. As a particular example, a machine learning model may be trained using at least one training dataset that includes training images, training camera parameters, and ground truth 3D object representations, and the machine learning model can be trained to accurately estimate 3D object representations that are close or identical to the ground truth 3D object representations using the training images and the training camera parameters.

An area of interest detection function 312 generally operates to process the images 302 in order to identify one or more areas of interest of the 3D object 112. For example, the area of interest detection function 312 can process the images 302 in order to detect one or more areas of interest in which at least one imperfection, damage, defect, part, or add-on of the 3D object 112 appears in at least one of the images 302. The area of interest detection function 312 may use any suitable technique to identify areas of interest associated with an object, such as by using a computer vision technique or a machine learning model that is designed or trained to process images 302 in order to identify areas of interest. As a particular example, a machine learning model may be trained using at least one training dataset that includes training images and ground truth areas of interest, and the machine learning model can be trained to accurately identify areas of interest that are close or identical to the ground truth areas of interest using the training images. Each identified area of interest can represent any suitable portion of a 3D object 112, such as by identifying a specific part of the 3D object 112 or by identifying an imperfection, damage, or defect of the 3D object 112.

A contour extraction function 314 generally operates to estimate contours of each identified area of interest in one or more of the images 302. Since the images 302 are 2D images, the identified contour of each area of interest can represent a 2D contour of the area of interest in one or more images 302. The contour extraction function 314 may use any suitable technique to identify the contour of each area of interest associated with an object, such as by using a computer vision technique or a machine learning model that is designed or trained to process images 302 in order to identify contours of areas of interest. As a particular example, a machine learning model may be trained using at least one training dataset that includes training images and training areas of interest and ground truth contours, and the machine learning model can be trained to accurately identify contours of the areas of interest that are close or identical to the ground truth contours using the training images and the training areas of interest.

A contour tracking function 316 generally operates to track movement of the 3D object 112 through a sequence of the images 302. Among other things, this allows the contour tracking function 316 to identify how an imaging sensor is moved around the 3D object 112 to acquire the images 302. This also gives the architecture 300 the ability to track each identified area of interest across different images 302. The contour tracking function 316 may use any suitable technique to track contours of areas of interest associated with an object, such as by using a computer vision technique or a machine learning model that is designed or trained to track contours of areas of interest. As a particular example, a machine learning model may be trained using at least one training dataset that includes training images and ground truth contours, and the machine learning model can be trained to accurately track contours of the areas of interest that are close or identical to the ground truth contours using the training images. In some cases, the temporal cohesion between the images 302 (particularly for images 302 in a video sequence) can be used to estimate a camera path over an image capture period during which the images 302 are captured, such as by using a point-to-point tracking method. The tracking of the contours across multiple images 302 may help the architecture 300 to more accurately identify the contours of the areas of interest in individual ones of the images 302.

A contour translation function 318 generally operates to convert 2D contours for areas of interest into 3D contours associated with the 3D representation of the object 112. For example, the contour translation function 318 may use an aggregation and merging process that (i) transforms the 2D contour determined for each area of interest into an intermediate 3D contour for each image 302 and (ii) aggregates the intermediate 3D contours for each area of interest to define a single 3D space for the area of interest. In some cases, the aggregation and merging process can involve using the images 302, depth information associated with a scene that includes the object 112, and the 3D representation of the object 112 in order to transform the 2D contours into 3D contours. Moreover, the aggregation of the 3D contours can be done for different views of the same area of interest, which may help to more precisely define the 3D contours of the area of interest and avoid duplicate areas of interest.

An area of interest measurement and location estimation function 320 generally operates to estimate, for each area of interest, an absolute size and location of the area of interest on the 3D representation of the object 112. This can be achieved since the 3D representation of the object 112 allows the location of each area of interest to be identified based on its associated 3D contour. This can also be achieved since the 3D representation of the object 112 can be generated with absolute metrics (such as meters or centimeters), which means combining the 3D representation of the object 112 with the 3D contour of an area of interest allows for computation of the estimated size of the area of interest. In other words, each 3D area of interest can be measured in terms of absolute area units (like square meters or square centimeters) because the 3D representation of the object 112 is generated in absolute size (so absolute metrics like meters or centimeters can be measured). It is also possible to estimate other characteristics of each area of interest. For instance, the orientation of each area of interest relative to the object 112 may be determined, such as by determining whether the 3D contour of an area of interest runs up and down, left to right, or diagonally along a surface of the object 112.

The size and location of at least one area of interest may be used in any suitable manner. In this example, a graphical user interface (GUI) 322 may be generated using or based on the size and location of at least one area of interest for the object 112. As a particular example, the graphical user interface 322 may include a 2D or 3D image of the object 112 and identify each area of interest on the 2D or 3D image, where the location and size of the area of interest on the 2D or 3D image is based on the outputs from the area of interest measurement and location estimation function 320. Thus, for instance, each area of interest may be overlaid over the appropriate location in a 2D image of the object 112 or over the appropriate location in a 3D model of the object 112. In some cases, a 3D model may be presented to a user via an XR device (such as an XR headset or glasses) so that the user can interact with the 3D model and view each area of interest. As another example, a report 324 may also or alternatively be generated using or based on the size and location of at least one area of interest for the object 112. As a particular example, the report 324 may represent a text report or other report where information about the object 112 (including information about its area or areas of interest) are shown or described. Note, however, that the size(s) and location(s) of one or more areas of interest associated with one or more objects 112 may be used in any other suitable manner.

The architecture 300 effectively allows processing of images 302 of an object 112 using advanced computer vision, machine learning, or other techniques to reconstruct the object 112 in three dimensions, detect one or multiple areas of interest in at least some of the images 302, establish movement of the object 112 across the images 302, and estimate the absolute size and position (and possibly one or more other characteristics) of each area of interest in the 3D reconstructed object. In some embodiments, this can be accomplished solely using images 302 of the object 112, where the images 302 can be obtained from any suitable device or devices. In other cases, it is possible to combine the processing of the images 302 with other data processing, such as processing operations involving positioning data (like data from an accelerometer, a satellite navigation system, a stereo sensor, or a wireless signal-based location), 3D data (like data from a LIDAR or photogrammetric sensor), and/or depth data (like data from an active or passive depth sensor).

There are various ways in which the architecture 300 shown in FIG. 3 may be implemented. For example, in some embodiments, all functionality of the architecture 300 may be implemented within a user device 102a-102f. In other embodiments, a user device 102a-102f may include a native application that can be used to capture the images 302, and the user device 102a-102f can provide the images 302 and its camera parameter(s) 304 to a cloud service or other remote device for processing. In still other embodiments, a user device 102a-102f may include a browser that allows captured images 302 to be provided, and the user device 102a-102f can provide the images 302 to a cloud service or other remote device for processing (part of which may include estimating the camera parameter(s) 304 of the user device 102a-102f). In yet other embodiments, a user device 102a-102f may capture the images 302 and provide the images 302 (possibly along with the camera parameter(s) 304) to an intermediate platform, and a cloud service or other remote device can retrieve the images 302 (and possibly the camera parameter(s) 304) for processing.

In some cases, the actual implementation of the architecture 300 can vary depending on the capabilities of a user device 102a-102f being used. For example, when an image processing application is installed on the user device 102a-102f, the application could evaluate the user device's capabilities and determine whether the user device 102a-102f fulfills any specified requirements for image processing to be performed on the user device 102a-102f. If not, the processing can be performed in a cloud-based environment or otherwise remotely, and the user device 102a-102f can transmit the information to be processed. Thus, the computer vision, machine learning, or other tasks of the architecture 300 can be performed on the user device 102a-102f itself or remotely depending on the hardware and software capabilities of the user device 102a-102f. If the user device 102a-102f lacks the capabilities to support the application, the images 302 and other information may be stored, such as in a storage system connected to a more powerful platform. Note that if data is transmitted from the user device 102a-102f for processing, the data may be compressed and/or encrypted before transmission, and a cloud service or other remote system can decompress and/or decrypt the data for processing. Also note that these example embodiments are for illustration only and that the architecture 300 may be implemented in any other suitable manner.

In some embodiments, it is possible to use data derived from the images 302 along with a reference 3D model of an object 112 when performing one or more of the functions described above. For example, a reference 3D model may represent a previous known 3D structure of an object 112 or an expected 3D structure of the object 112. As a particular example, when an object 112 represents an automotive vehicle, a reference 3D model may represent a 3D structure of the automotive vehicle as defined by the manufacturer of the automotive vehicle. The reference 3D model may be used in various ways by the architecture 300, such as when the architecture 300 uses the location of an area of interest to associate the area of interest with a specific part of the object 112. Thus, for instance, the architecture 300 may be able to localize an area of interest representing an imperfection, damage, or defect to a specific portion of a specific part of an automotive vehicle, such as when the architecture 300 is able to determine that an area of interest representing damage to the automotive vehicle is located at a specific position on the hood of the automotive vehicle.

Although FIG. 3 illustrates one example of a functional architecture 300 supporting image processing to measure the absolute size and location of an area of interest associated with an object, various changes may be made to FIG. 3. For example, various functions and components shown in FIG. 3 may be combined, further subdivided, replicated, omitted, or rearranged and additional functions and components may be added according to particular needs. Also, while FIG. 3 describes the functions of the architecture 300 in a specified order, the actual ordering of the functions can vary depending on the implementation. For instance, it is possible to translate an area of interest's contours from 2D to 3D prior to tracking the area of interest's contours across different images 302 and combining them.

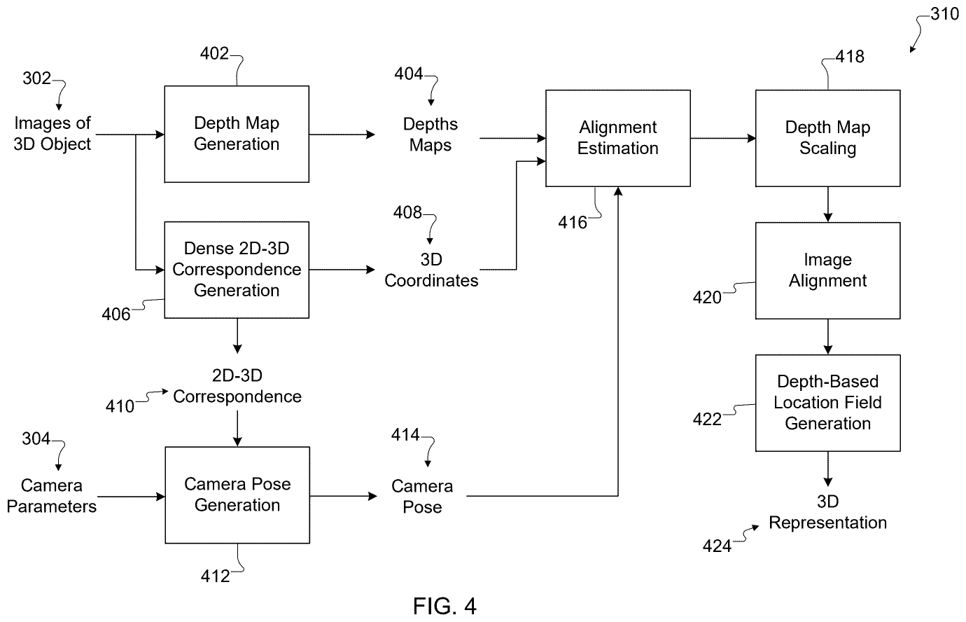

FIG. 4 illustrates an example 3D object representation generation function 310 in the functional architecture 300 of FIG. 3 according to this disclosure. For ease of explanation, the 3D object representation generation function 310 shown in FIG. 4 is described as being used as part of the architecture 300 shown in FIG. 3, which may be implemented using at least one instance of the device 200 shown in FIG. 2 (such as in a user device 102a-102f and/or an application server 106). However, the 3D object representation generation function 310 shown in FIG. 4 may be used with any suitable device(s) and with any suitable system(s).

As shown in FIG. 4, the 3D object representation generation function 310 receives the images 302 and the one or more camera parameters 304. As noted above, the one or more camera parameters 304 may represent one or more actual camera parameters used by the imaging device to capture the images 302 or one or more estimated camera parameters. The images 302 are provided to a depth map generation function 402, which generally operates to process the images 302 and generate depth maps 404 associated with the images 302. Each depth map 402 includes projected depths within a scene as captured in a corresponding image 302. For example, each depth map 404 may include pixel values, where each pixel value in the depth map 404 is associated with a corresponding pixel in the associated image 302 and identifies the predicted depth of the scene at that pixel in the associated image 302. The depth map generation function 402 may use any suitable technique to generate depth maps 404. Various techniques are known for generating depth maps, and additional techniques are sure to be developed in the future.

The images 302 are also provided to a dense 2D-3D correspondence generation function 406, which generally operates to process the images 302 and generate 3D coordinates 408 and 2D-3D correspondences 410 associated with the images 302. For example, the dense 2D-3D correspondence generation function 406 may estimate 3D coordinates of certain points of at least one object 112 within a scene and relationships between 2D pixels of images capturing a scene and 3D surface coordinates of the at least one object 112 within the scene. The dense 2D-3D correspondence generation function 406 can therefore operate to identify various 3D coordinates 408 associated with an object 112 captured in the images 302 and the relationship (correspondence 410) between 2D points in the images 302 and 3D surfaces of the object 112. The dense 2D-3D correspondence generation function 406 may use any suitable technique to generate 3D coordinates 408 and 2D-3D correspondences 410. Various techniques are known for generating coordinates and 2D-3D correspondences, and additional techniques are sure to be developed in the future.

The one or more camera parameters 304 and the at least one 2D-3D correspondence 410 are processed using a camera pose generation function 412, which generally operates to identify camera poses 414 associated with the images 302. Each camera pose 414 identifies the estimated pose of the imaging device while capturing at least one of the images 302. Often times, camera poses can be expressed using six degrees of freedom, such as translations (distances) along three orthogonal axes and rotations (angles) about those three orthogonal axes. The camera pose generation function 412 may use any suitable technique to generate camera poses 414. Various techniques are known for generating camera poses, and additional techniques are sure to be developed in the future.

The images 302, depth maps 404, 3D coordinates 408, and camera poses 414 are provided to an alignment estimation function 416, which generally operates to determine how to align the images 302 based on the depth maps 404, 3D coordinates 408, and camera poses 414. For example, the alignment estimation function 416 can process the various inputs in order to generate point-to-point correspondences between common points captured in different images 302. The point-to-point correspondences can identify where the same point within a scene is captured in multiple images 302, and this can be repeated for any number of points within the scene. The alignment estimation function 416 may use any suitable technique to estimate how to align captured images. Various techniques are known for aligning images, and additional techniques are sure to be developed in the future.

A depth scaling function 418 generally operates to process the images 302, alignment estimates, and other information in order to scale the depth maps 404 so that the scaled depths maps have a common scale (unit of measurement). For example, the depth scaling function 418 may scale various depth maps 404 so that all of the scaled depth maps are scaled to a world coordinate system defined for the scene captured in the images 302. The depth scaling function 418 may use any suitable technique to scale depth maps. Various techniques are known for scaling depth maps, and additional techniques are sure to be developed in the future.

An image alignment function 420 generally operates to align the captured images 302 based at least on the scaled depth maps. For example, the image alignment function 420 can translate and/or rotate at least some of the images 302 in order to generate aligned versions of the images 302. As a result, the images 302 can be adjusted so that common points within the scene are located at common pixel locations in the aligned versions of the images 302. The image alignment function 420 may use any suitable technique to align images. Various techniques are known for aligning images, and additional techniques are sure to be developed in the future.

A depth-based location field generation function 422 processes the aligned versions of the images 302 in order to generate a 3D representation 424 of the object 112 captured in the images 302. Here, the location field that is generated can provide a more accurate and more detailed encoding of 2D pixels in the aligned versions of the images 302 and 3D surface coordinates of the object 112. The depth-based location field generation function 422 may use any suitable technique to generate a 3D representation of an object 112. Various techniques are known for generating location fields, and additional techniques are sure to be developed in the future.

Although FIG. 4 represents one example of a 3D object representation generation function 310 in the functional architecture 300 of FIG. 3, various changes may be made to FIG. 4. For example, various functions and components shown in FIG. 4 may be combined, further subdivided, replicated, omitted, or rearranged and additional functions and components may be added according to particular needs. Also, while FIG. 4 illustrates one example technique for generating a 3D representation of an object 112, the architecture 300 may use any other suitable technique to generate a 3D representation of an object 112, such as any suitable 3D reconstruction algorithm.

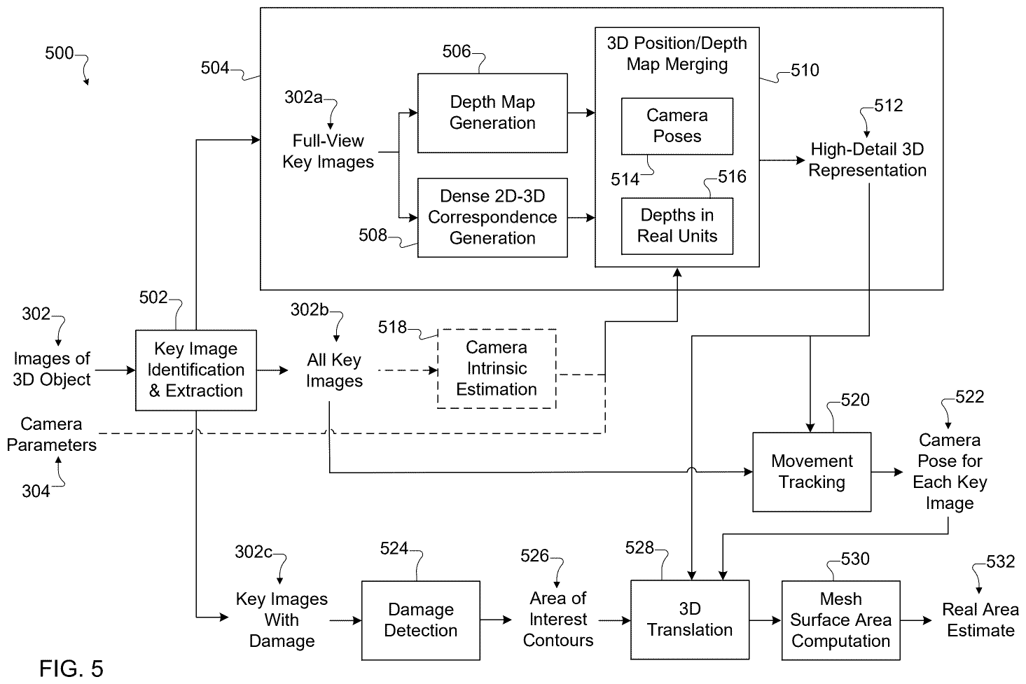

FIG. 5 illustrates an example pipeline 500 supporting image processing to measure the absolute size and location of an area of interest associated with an object according to this disclosure. More specifically, FIG. 5 illustrates a specific example of how the architecture 300 shown in FIG. 3 may be implemented. For ease of explanation, the pipeline 500 shown in FIG. 5 may be implemented using at least one instance of the device 200 shown in FIG. 2 (such as in a user device 102a-102f and/or an application server 106). However, the pipeline 500 shown in FIG. 5 may be used with any suitable device(s) and with any suitable system(s).

As shown in FIG. 5, the images 302 are received and processed using a key image identification and extraction function 502, which may represent a specific implementation of the image acquisition function 306. The key image identification and extraction function 502 can identify specific images 302 from a sequence or other collection of images 302 to be used during subsequent image processing. As a particular example, the key image identification and extraction function 502 can identify specific images 302 meeting one or more criteria, such as images 302 that have at least a specified resolution or clarity. In some cases, this may be useful when the images 302 are contained within a video sequence or other image sequence. In this example, the key image identification and extraction function 502 identifies three different sets of images 302. One set 302a of images 302 represents a collection of full-view key images, meaning most or all of an object 112 is captured within those images 302. Another set 302b of images 302 represents a collection of all key images 302 identified by the key image identification and extraction function 502. A third set 302c of images 302 represents a collection of key images 302 that might capture imperfections, damage, or defects associated with the object 112.

The set 302a of images 302 is provided to a 3D representation generation function 504, which may represent a specific implementation of the 3D object representation generation function 310. For each image 302 in the set 302a, the 3D representation generation function 504 can process the image 302 using a depth map generation function 506 and a dense 2D-3D correspondence generation function 508. In some embodiments, the depth map generation function 506 may represent a specific implementation of the depth map generation function 402, and the dense 2D-3D correspondence generation function 508 may represent a specific implementation of the dense 2D-3D correspondence generation function 406. A 3D position/depth map merging function 510 can be used to merge the 3D position information and the depth maps. In some embodiments, the 3D position/depth map merging function 510 may represent a specific implementation of the functions 414-420. As shown here, the 3D position/depth map merging function 510 can use camera poses 514 and depths 516 in real units of measurement. The camera poses 514 may be determined as described above and may represent the camera poses 412, and the depths 516 may be determined as part of the depth scaling function 418.

The set 302b of all key images 302 may optionally be provided to a camera intrinsic estimation function 518, which can estimate one or more intrinsic parameters of the imaging device that captured the images 302. In some embodiments, the intrinsic estimation function 518 may represent a specific implementation of the camera parameter acquisition function 308. The camera intrinsic estimation function 518 is shown here as being optional since the one or more intrinsic parameters of the imaging device may also be obtained in other ways, such as directly from the imaging device. In whatever manner the one or more intrinsic parameters are obtained, the one or more intrinsic parameters can be provided to the 3D position/depth map merging function 510 for use in generating the 3D representation 512 of the object 112. The set 302b of all key images 302 is provided to a movement tracking function 520, which generally operates to track movement of the object 112 across the images 302 of the set 302b. Among other things, this allows the movement tracking function 520 to estimate a camera pose 522 for each of the key images 302 in the set 302b.

The images 302 in the set 302c are provided to a damage detection function 524, which can identify contours 526 for one or more areas of interest (such as damage or other imperfections). In some embodiments, the damage detection function 524 may represent a specific implementation of the area of interest detection function 312 and the contour extraction function 314. The contours 526 are provided to a 3D translation function 528, which can track each area of interest across different images 302 and translate the contours 526 into a 3D area of interest. In some embodiments, the 3D translation function 528 may represent a specific implementation of the contour tracking function 316 and the contour translation function 318. The one or more resulting 3D areas of interest are provided to a mesh surface area computation function 530, which can process each 3D areas of interest and generate a real area estimate 532 associated with the 3D areas of interest. In some embodiments, the mesh surface area computation function 530 may represent a specific implementation of the area of interest measurement and location estimation function 320.

Although FIG. 5 illustrates one example of a pipeline 500 supporting image processing to measure the absolute size and location of an area of interest associated with an object, various changes may be made to FIG. 5. For example, various functions and components shown in FIG. 5 may be combined, further subdivided, replicated, omitted, or rearranged and additional functions and components may be added according to particular needs. Also, while FIG. 5 describes one specific implementation of a pipeline 500, pipelines can come in a variety of configurations, and other configurations of pipelines may be used here.

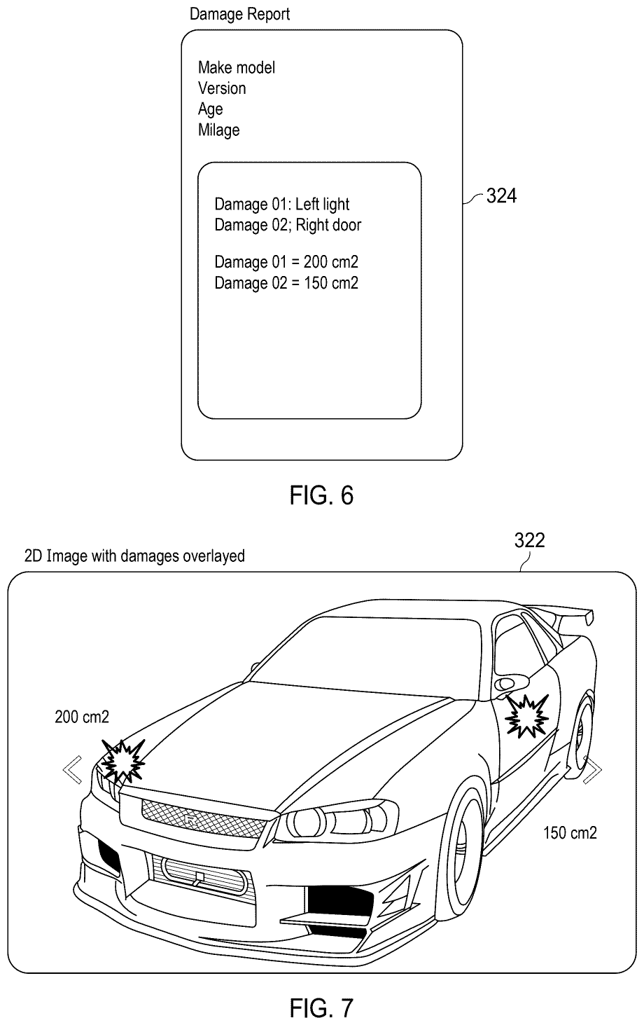

FIGS. 6 through 8 illustrate example results obtained using image processing to measure the absolute size and location of an area of interest associated with an object according to this disclosure. For ease of explanation, the results shown in FIGS. 6 through 8 are described as being generated using the architecture 300 shown in FIG. 3. However, the architecture 300 may generate outputs that can be used in any other suitable manner.

As shown in FIG. 6, one example of a report 324 is shown, where the report 324 includes a description of the size and location of each of one or more areas of interest. In this example, the report 324 is associated with a damaged vehicle, and the report 324 includes a location and a size of one or more instances of damage to the damaged vehicle. The report 324 may also include information about the object 112 itself. In this example, the report 324 identifies the make and model of the damaged vehicle, a version of the damaged vehicle, an age of the damaged vehicle, and a mileage of the damaged vehicle. Note, however, that the report 324 may include any other or additional information about the associated object 112, such as an identification of the user device 102a-102f that captured the images 302. Also note that the report 324 may include other or additional content, such as one or more images of the object 112.

As shown in FIG. 7, one example of a graphical user interface 322 is shown, where the graphical user interface 322 includes a 2D image of the object 112 along with a location indicator and size for each of one or more areas of interest. In this example, the graphical user interface 322 is associated with a damaged vehicle, and the graphical user interface 322 identifies a location and a size of one or more instances of damage to the damaged vehicle. Arrows or other controls may be used to view different images of the object 112, and each image may include a suitable location indicator and size for each of one or more areas of interest. While not shown here, each area of interest can be associated with some type of visual indicator (such as color or highlighting) to distinguish each area of interest from the image of the object 112. In some cases, each 2D image of the object 112 presented in the graphical user interface 322 may represent one of the images 302 processed by the architecture 300. In other cases, each 2D image of the object 112 presented in the graphical user interface 322 may represent a stock or generic image representing the object 112.

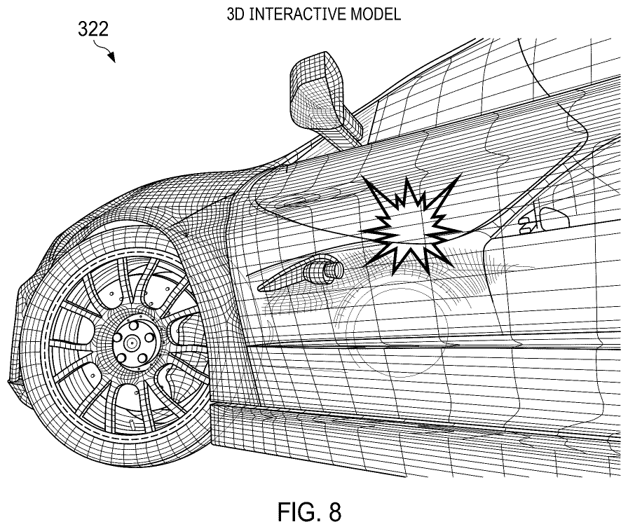

As shown in FIG. 8, another example of a graphical user interface 322 is shown, where the graphical user interface 322 includes a 3D model of the object 112 along with a location indicator and size for each of one or more areas of interest. Again, in this example, the graphical user interface 322 is associated with a damaged vehicle, and the graphical user interface 322 identifies a location one or more instances of damage to the damaged vehicle. In some cases, the 3D model may be presented to a user on an XR headset or glasses, and the user may be allowed to virtually manipulate the 3D model to rotate the model or zoom in or out. Similar operations may be performed when the 3D model is presented on the display of another type of user device. While not shown here, each area of interest can be associated with some type of visual indicator (such as color or highlighting) to distinguish each area of interest from the image of the object 112. In some cases, the 3D model of the object 112 presented in the graphical user interface 322 may represent a 3D model derived based on the images 302 processed by the architecture 300. In other cases, the 3D model of the object 112 presented in the graphical user interface 322 may represent a stock or generic 3D model representing the object 112.

Although FIGS. 6 through 8 illustrate examples of results obtained using image processing to measure the absolute size and location of an area of interest associated with an object, various changes may be made to FIGS. 6 through 8. For example, results obtained using image processing to measure the absolute size and location of an area of interest associated with an object may be used in any other suitable manner. As particular examples, results obtained using image processing to measure the absolute size and location of an area of interest associated with an object may be used to generate a cost estimate for repairing damage to the object, generate a parts list or order parts for repairing damage to the object, perform quality control to determine whether the object satisfies one or more quality control criteria, or perform object classification.

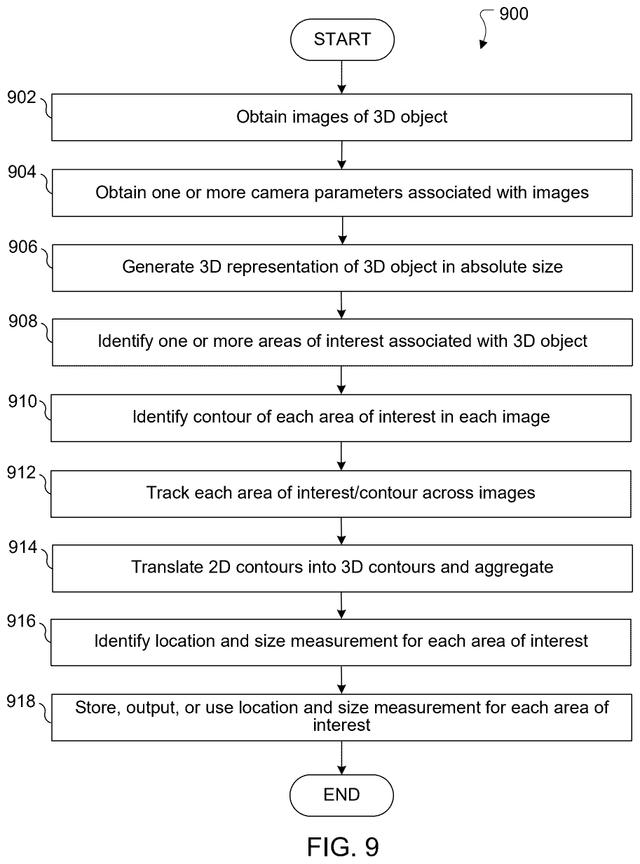

FIG. 9 illustrates an example method 900 for image processing to measure the absolute size and location of an area of interest associated with an object according to this disclosure. For ease of explanation, the method 900 shown in FIG. 9 is described as being performed using the architecture 300 shown in FIG. 3, which may be implemented using at least one instance of the device 200 shown in FIG. 2 (such as in a user device 102a-102f and/or an application server 106). However, the method 900 shown in FIG. 9 may be performed using any suitable device(s) and in any suitable system(s).

As shown in FIG. 9, images of a 3D object are obtained at step 902. In some embodiments, this may include, for example, the processing device 202 of a user device 102a-102f performing the image acquisition function 306 to obtain images 302 of an object 112 using one or more imaging sensors of the user device 102a-102f. In other embodiments, this may include the processing device 202 of an application server 106 performing the image acquisition function 306 to obtain the images 302 of the object 112 from a user device 102a-102f, database 110, or other source(s). In general, the images 302 of the object 112 may be obtained in any suitable manner.

One or more camera parameters associated with the images are obtained at step 904. In some embodiments, this may include, for example, the processing device 202 of the user device 102a-102f or application server 106 performing the camera parameter acquisition function 308 to obtain the one or more camera parameters 304 from the user device 102a-102f. In other embodiments, this may include the processing device 202 of the application server 106 performing the camera parameter acquisition function 308 to estimate the one or more camera parameters 304 based on the images 302 or other information available from the user device 102a-102f. In general, the one or more camera parameters 304 may be obtained in any suitable manner.

A 3D representation of the object in absolute size is generated at step 906. This may include, for example, the processing device 202 of the user device 102a-102f or application server 106 performing the 3D object representation generation function 310 to process the images 302 in order to generate a 3D representation of the object 112. As a particular example, this may include the processing device 202 of the user device 102a-102f or application server 106 transforming the pixels of the images 302 into 3D coordinates. With knowledge of the one or more camera parameters 304 (such as focal length), it is possible to transform the pixels of the images 302 into 3D coordinates with absolute metrics, such as in terms of meters or centimeters.

One or more areas of interest associated with the 3D object are identified at step 908. This may include, for example, the processing device 202 of the user device 102a-102f or application server 106 performing the area of interest detection function 312 to detect areas of the object 112 where at least one imperfection, damage, defect, part, or add-on is located. A contour of each area of interest is identified in each image at step 910. This may include, for example, the processing device 202 of the user device 102a-102f or application server 106 performing the contour extraction function 314 to identify the contour of each area of interest in each image 302.

Each area of interest is tracked across different images at step 912. This may include, for example, the processing device 202 of the user device 102a-102f or application server 106 performing the contour tracking function 316 to track each area of interest in different images 302 so that different contours associated with the same area of interest can be identified. The contours are translated from 2D contours to 3D contours at step 914. This may include, for example, the processing device 202 of the user device 102a-102f or application server 106 performing the contour translation function 318 to convert each 2D contour into a 3D contour based on the 3D representation of the object 112 and combining the 3D contours associated with each area of interest to produce a final 3D contour for that area of interest.

A location and size measurement for each area of interest are identified at step 916. This may include, for example, the processing device 202 of the user device 102a-102f or application server 106 performing the area of interest measurement and location estimation function 320 to identify where each 3D contour of an area of interest is located on the 3D representation of the object 112. This may also include the processing device 202 of the user device 102a-102f or application server 106 performing the area of interest measurement and location estimation function 320 to identify an absolute size of each area of interest based on the 3D contour of the area of interest and the known absolute size of the object 112 as defined by the 3D representation. The location and size measurement for each area of interest can be stored, output, or used in some manner at step 918. This may include, for example, the processing device 202 of the user device 102a-102f or application server 106 generating a graphical user interface 322, report 324, or other output based on the location and size measurement for at least one identified area of interest.

Although FIG. 9 illustrates one example of a method 900 for image processing to measure the absolute size and location of an area of interest associated with an object, various changes may be made to FIG. 9. For example, while shown as a series of steps, various steps in FIG. 9 may overlap, occur in parallel, occur in a different order, or occur any number of times (including zero times).

It should be noted that the functions shown in or described with respect to FIGS. 3 through 9 can be implemented in a user device 102a-102f, application server 106, or other device(s) in any suitable manner. For example, in some embodiments, at least some of the functions shown in or described with respect to FIGS. 3 through 9 can be implemented or supported using one or more software applications or other software instructions that are executed by the processing device 202 of the user device 102a-102f, application server 106, or other device. In other embodiments, at least some of the functions shown in or described with respect to FIGS. 3 through 9 can be implemented or supported using dedicated hardware components. In general, the functions shown in or described with respect to FIGS. 3 through 9 can be performed using any suitable hardware or any suitable combination of hardware and software/firmware instructions. Also, the functions shown in or described with respect to FIGS. 3 through 9 can be performed using any number of devices.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining, using at least one processing device, multiple images of a three-dimensional (3D) object;
generating, using the at least one processing device, a 3D representation of the object with absolute metrics based on the images;
detecting, using the at least one processing device, one or more areas of interest associated with the object based on the images;
identifying, using the at least one processing device, a 3D contour of each area of interest, each 3D contour identifying the area of interest within the 3D representation of the object; and
determining, using the at least one processing device, a location and an absolute size of each area of interest on the object based on the 3D contour of the area of interest and the 3D representation of the object.

2. The method of claim 1, wherein identifying the 3D contour of each area of interest comprises:
identifying 2D contours for each area of interest in the images;
converting the 2D contours into intermediate 3D contours; and
aggregating the intermediate 3D contours for each area of interest to generate the 3D contour for the area of interest.

3. The method of claim 2, wherein identifying the 3D contour of each area of interest further comprises:
tracking each area of interest across the images to identify 2D contours that are associated with one another.

4. The method of claim 3, wherein:
the images comprise images in a video sequence; and
tracking each area of interest across the images comprises using temporal cohesion between the images to estimate a camera path over an image capture period during which the images are captured.

5. The method of claim 1, further comprising:
determining if one or more camera parameters associated with the images are available; and
one of:
using the one or more camera parameters that are available to generate the 3D representation of the object; or
estimating the one or more camera parameters based on the images and using the one or more estimated camera parameters to generate the 3D representation of the object.

6. The method of claim 1, wherein at least one trained machine learning model is used to at least one of: generate the 3D representation of the object, detect the one or more areas of interest, or identify the 3D contour of each area of interest.

7. The method of claim 1, further comprising:
generating at least one of a graphical user interface or a report that identifies the location and the absolute size of at least one of the one or more areas of interest.

8. An apparatus comprising:
at least one processing device configured to:
obtain multiple images of a three-dimensional (3D) object;
generate a 3D representation of the object with absolute metrics based on the images;
detect one or more areas of interest associated with the object based on the images;
identify a 3D contour of each area of interest, each 3D contour identifying the area of interest within the 3D representation of the object; and
determine a location and an absolute size of each area of interest on the object based on the 3D contour of the area of interest and the 3D representation of the object.

9. The apparatus of claim 8, wherein, to identify the 3D contour of each area of interest, the at least one processing device is configured to:
identify 2D contours for each area of interest in the images;
convert the 2D contours into intermediate 3D contours; and
aggregate the intermediate 3D contours for each area of interest to generate the 3D contour for the area of interest.

10. The apparatus of claim 9, wherein, to identify the 3D contour of each area of interest, the at least one processing device is further configured to track each area of interest across the images to identify 2D contours that are associated with one another.

11. The apparatus of claim 10, wherein:
the images comprise images in a video sequence; and
to track each area of interest across the images, the at least one processing device is configured to use temporal cohesion between the images to estimate a camera path over an image capture period during which the images are captured.

12. The apparatus of claim 8, wherein the at least one processing device is further configured to:
determine if one or more camera parameters associated with the images are available;
use the one or more camera parameters that are available to generate the 3D representation of the object; and
estimate the one or more camera parameters based on the images and use the one or more estimated camera parameters to generate the 3D representation of the object.

13. The apparatus of claim 8, wherein the at least one processing device is configured to use at least one trained machine learning model to at least one of: generate the 3D representation of the object, detect the one or more areas of interest, or identify the 3D contour of each area of interest.

14. The apparatus of claim 8, wherein the at least one processing device is further configured to generate at least one of a graphical user interface or a report that identifies the location and the absolute size of at least one of the one or more areas of interest.

15. A non-transitory machine readable medium containing instructions that when executed cause at least one processor to:
obtain multiple images of a three-dimensional (3D) object;
generate a 3D representation of the object with absolute metrics based on the images;
detect one or more areas of interest associated with the object based on the images;
identify a 3D contour of each area of interest, each 3D contour identifying the area of interest within the 3D representation of the object; and
determine a location and an absolute size of each area of interest on the object based on the 3D contour of the area of interest and the 3D representation of the object.

16. The non-transitory machine readable medium of claim 15, wherein the instructions that when executed cause the at least one processor to identify the 3D contour of each area of interest comprise:
instructions that when executed cause the at least one processor to:
identify 2D contours for each area of interest in the images;
convert the 2D contours into intermediate 3D contours; and
aggregate the intermediate 3D contours for each area of interest to generate the 3D contour for the area of interest.

17. The non-transitory machine readable medium of claim 16, wherein the instructions that when executed cause the at least one processor to identify the 3D contour of each area of interest further comprise:
instructions that when executed cause the at least one processor to track each area of interest across the images to identify 2D contours that are associated with one another.

18. The non-transitory machine readable medium of claim 17, wherein:
the images comprise images in a video sequence; and
the instructions that when executed cause the at least one processor to track each area of interest across the images comprise:
instructions that when executed cause the at least one processor to use temporal cohesion between the images to estimate a camera path over an image capture period during which the images are captured.

19. The non-transitory machine readable medium of claim 15, further containing instructions that when executed cause the at least one processor to:
determine if one or more camera parameters associated with the images are available;
use the one or more camera parameters that are available to generate the 3D representation of the object; and
estimate the one or more camera parameters based on the images and use the one or more estimated camera parameters to generate the 3D representation of the object.

20. The non-transitory machine readable medium of claim 15, wherein the instructions when executed cause the at least one processor to use at least one trained machine learning model to at least one of: generate the 3D representation of the object, detect the one or more areas of interest, or identify the 3D contour of each area of interest.

21. The non-transitory machine readable medium of claim 15, further containing instructions that when executed cause the at least one processor to generate at least one of a graphical user interface or a report that identifies the location and the absolute size of at least one of the one or more areas of interest.
